(19) United States
(12) Patent Application Publication
(10) Pub. No.: US 2025/0355737 A1
(43) Pub. Date: Nov. 20, 2025

(54) Efficient Scheduling of Near Real Time Radio Access Network Intelligent Controller XAPPS

(71) Applicant: Dell Products L.P., Round Rock, TX (US)

(72) Inventors: Ahmed Nader HASSAN HASSAN, Madinaty (EG); Abdel Rahman Mohammed ABDEL RAHMAN SELEEM SALEH, SHARKIA (EG)

(21) Appl. No.: 18/668,772

(22) Filed: May 20, 2024

(51) Int. Cl. G06F 9/54; G06Q 30/0283; H04W 24/02

(52) U.S. Cl. CPC G06F 9/547; H04W 24/02; G06Q 30/0283

(57) ABSTRACT

Efficient scheduling of near-RT RIC xApps (e.g., using a computerized tool), is enabled. For example, a process can comprise, based on one or more defined system specifications applicable to an xApp, determining, from first nodes, second nodes capable of executing the xApp according to the one or more defined system specifications, wherein the second nodes are a subset of the first nodes, determining respective dependencies of the second nodes, based on the respective dependencies, determining respective latencies applicable to the second nodes to execute the xApp, based on the respective latencies, determining third nodes that satisfy a defined latency threshold, wherein the third nodes are a subset of the second nodes, according to a defined operational cost function, ranking the third nodes based on respective operational costs, and selecting a node of the third nodes comprising an operational cost of the respective operational costs that satisfies a defined cost criterion.

### BACKGROUND

Open radio access network (O-RAN) is a technology that enables network operators to easily integrate different components from different vendors, for instance, by suggesting new open interfaces and architecture. Moreover, O-RAN introduces the intelligence of a RAN through Near-Realtime RAN Intelligent Controller (near-RT RIC) and a Non-RT RIC, which enable different vendors deploying different xApps and rApps that improve network performance in different network slices. The Near-RT RIC runs applications (e.g., xApps) that establish control loops constrained to time intervals, for instance, between 10 ms and 1 s. The time constraint of a given control loop depends on the RAN function under the management of the corresponding xApp. For example, an xApp related to medium access management may need to complete the control loop within a 10 ms threshold, while an xApp related to user session management may tolerate longer delays of up to 1 s.

Edge computing requires the deployment of computing resources, such as servers, networking equipment, and data storage devices, closer to the data source or endpoint devices. This, for instance, leads to increased costs for setting up and maintaining the required hardware and infrastructure at multiple locations, especially in remote or challenging environments. Cloud computing also has associated costs for utilization of a corresponding cloud computing service.

The above-described background relating to RANs is merely intended to provide a contextual overview of some current issues and is not intended to be exhaustive. Other contextual information may become further apparent upon review of the following detailed description.

### BRIEF DESCRIPTION OF DRAWINGS

FIG. 1 is a block diagram of a non-limiting example system in accordance with one or more example embodiments described herein.

FIG. 2 is a block diagram of a non-limiting example RIC in accordance with one or more example embodiments described herein.

FIG. 3 is a block diagram of a non-limiting example computer executable modules in accordance with one or more example embodiments described herein.

FIG. 4 is a block diagram of a non-limiting example Kubernetes scheduling in accordance with one or more example embodiments described herein.

FIG. 5 is a flowchart for a process associated with efficient scheduling of near RT RIC xApps in accordance with one or more example embodiments described herein.

FIG. 6 is a flow diagram for a process associated with efficient scheduling of near RT RIC xApps in accordance with one or more example embodiments described herein.

FIG. 7 is a flow diagram for a process associated with efficient scheduling of near RT RIC xApps in accordance with one or more example embodiments described herein.

FIG. 8 is a flow diagram for a process associated with efficient scheduling of near RT RIC xApps in accordance with one or more example embodiments described herein.

FIG. 9 is an example, non-limiting computing environment in which one or more embodiments described herein can be implemented.

FIG. 10 is an example, non-limiting networking environment in which one or more embodiments described herein can be implemented.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As alluded to above, xApp scheduling can be improved in various ways, and various embodiments are described herein to this end and/or other ends. The disclosed subject matter relates to xApp scheduling and, more particularly, to efficient scheduling of near RT RIC xApps.

According to an example embodiment, a system can comprise at least one processor, and at least one memory that stores executable instructions that, when executed by the processor, facilitate performance of operations, comprising, based on one or more defined system requirements applicable to an xApp, determining, from a first group of servers, a second group of servers capable of executing the xApp, wherein the second group of servers is a subset of the first group of servers, determining dependencies of the second group of servers, based on the dependencies, determining latencies applicable to the second group of servers to execute the xApp, based on the latencies, determining a third group of servers that satisfy a defined latency threshold, wherein the third group of servers is a subset of the second group of servers, according to a defined operational cost function, ranking the third group of servers based on respective operational costs, and selecting a server of the third group of servers comprising a threshold low operational cost of the respective operational costs.

In one or more example embodiments, selecting the server can comprise selecting the server of the third group of servers comprising the lowest operational cost of the respective operational costs.

In one or more example embodiments, the above operations can further comprise, in response to selecting the server, executing the xApp via the server, and in response to executing the xApp via the server, determining whether the defined latency threshold is still satisfied. In this regard, the above operations can further comprise, in response to a determination that the defined latency threshold is no longer satisfied, selecting a different server, other than the server, to execute the xApp, wherein the different server also comprises the threshold low operational cost.

In one or more example embodiments, the first group of servers can comprise one or more edge servers and one or more cloud servers.

In one or more example embodiments, the dependencies can comprise communicative connections between respective components of a radio intelligent controller.

In one or more example embodiments, the one or more defined system requirements can comprise at least one of a compute requirement applicable to the xApp, a memory requirement applicable to the xApp, a latency requirement applicable to the xApp, or a throughput requirement applicable to the xApp.

In one or more example embodiments, the xApp can comprise a Kubernetes based application.

In one or more example embodiments, the above operations can further comprise, in response to a change in the first group of servers, redetermining the second group of servers.

In another example embodiment, a non-transitory machine-readable medium can comprise executable instructions that, when executed by a processor, facilitate performance of operations, comprising, based on one or more defined system specifications applicable to an xApp, determining, from first nodes, second nodes capable of executing the xApp according to the one or more defined system specifications, wherein the second nodes are a subset of the first nodes, determining respective dependencies of the second nodes, based on the respective dependencies, determining respective latencies applicable to the second nodes to execute the xApp, based on the respective latencies, determining third nodes that satisfy a defined latency threshold, wherein the third nodes are a subset of the second nodes, according to a defined operational cost function, ranking the third nodes based on respective operational costs, and selecting a node of the third nodes comprising an operational cost of the respective operational costs that satisfies a defined cost criterion.

In one or more example embodiments, the above operations can further comprise, in response to selecting the node, executing the xApp via the node. In this regard, the above operations can further comprise, after executing the xApp via the node, determining whether the defined latency threshold is still satisfied. Further in this regard, the operations further comprise, in response to the determining indicating that the defined latency threshold is no longer satisfied, determining another node, other than the node, to execute the xApp.

In one or more example embodiments, the first nodes can comprise one or more edge nodes and one or more cloud nodes.

In one or more example embodiments, the respective dependencies can comprise communicative connections between respective modules of a radio intelligent controller.

In one or more example embodiments, the one or more defined system specifications can comprise at least one of a compute specification applicable to the xApp, a memory specification applicable to the xApp, a latency specification applicable to the xApp, or a throughput specification applicable to the xApp.

In yet another example embodiment, a method can comprise, based on one or more defined system requirements of an xApp, determining, by network equipment comprising at least one processor, from a first group of servers, a second group of servers capable of executing the xApp, wherein the second group of servers is a subset of the first group of servers, determining, by the network equipment, dependencies of the second group of servers, based on the dependencies, determining, by the network equipment, latencies applicable to the second group of servers to execute the xApp, based on the latencies, determining, by the network equipment, a third group of servers that satisfy a defined latency threshold, wherein the third group of servers is a subset of the second group of servers, according to a defined operational cost function, ranking, by the network equipment, the third group of servers based on respective operational costs resulting in respective ranks of the third group of servers, and based on an analysis of the respective ranks, selecting, by the network equipment, a server of the third group of servers comprising a lowest operational cost of the respective operational costs.

In various embodiments described herein, the RAN RIC in the O-RAN specification optimizes control algorithms for load balancing, mobility management, multi-connection control, quality of experience (QoE) management, and network energy saving. The Near-RT RIC executes applications (e.g., xApps) that establish control loops constrained to time intervals between 10 ms and 1 s. The time constraint of a given control loop depends on the RAN function under the management of the corresponding xApp. To meet these latency requirements, a current Near-RT RIC is deployed in edge datacenters, however edge computing nodes often present limited resources and are expensive compared to cloud computing nodes.

Embodiments herein enable a new approach of running a near-RT RIC across edge and cloud environments to minimize costs while meeting latency requirements. Embodiments herein further enable optimization of near-RT RIC operational costs, for instance, by extending container orchestrator schedulers to efficiently bind xApps to optimal nodes.

Embodiments herein comprise a scheduling process that can minimize the deployment cost of RIC components across edge-cloud continuum. For instance, the scheduling process can (1) filter nodes (e.g., servers or modules) based on compute resources (CPU, RAM, etc.), (2) filter nodes based on accumulated latency across the entire control loop, (3) give higher scores to nodes either in edge or cloud that would minimize the overall operational cost, and (4) select node with highest score to run the xApp. Embodiments herein also enable monitoring of latency across the xApp's control loop and ensure that the xApp continuously meets its latency requirement. Once there is a latency requirement violation, a system herein can trigger rescheduling of the xApp (e.g., to a different node).

Using one or more embodiments described herein, cloud machines (e.g., cloud servers) can be added to a cluster and new xApps can be deployed to the cloud machines, or existing xApps that are more latency tolerant to such cloud machines can be rescheduled to the cloud machines to free edge resources for the new xApps that are less latency tolerant. In this regard, embodiments herein enable intelligent selection of which nodes (e.g., servers) of the RIC to run in the edge, and which pieces run in the cloud, for instance, to ensure minimum costs while also meeting defined system threshold requirements (e.g., latencies).

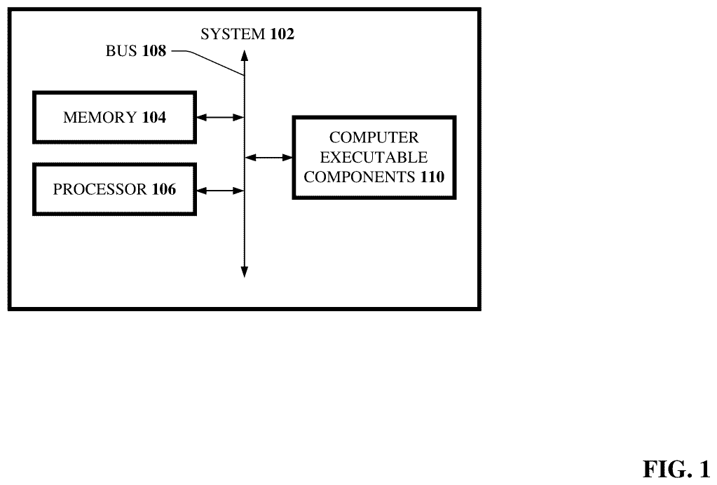

Turning now to FIG. 1, there is illustrated an example, non-limiting system 102 in accordance with one or more example embodiments herein. System 102 can comprise a computerized tool, which can be configured to perform various operations relating to efficient scheduling of near RT RIC xApps. The system 102 can comprise one or more of a variety of components, such as memory 104, processor 106, bus 108, and/or computer executable components 110. In various embodiments, one or more of the memory 104, processor 106, bus 108, and/or computer executable components 110 can be communicatively or operably coupled (e.g., over a bus or wireless network) to one another to perform one or more functions of the system 102.

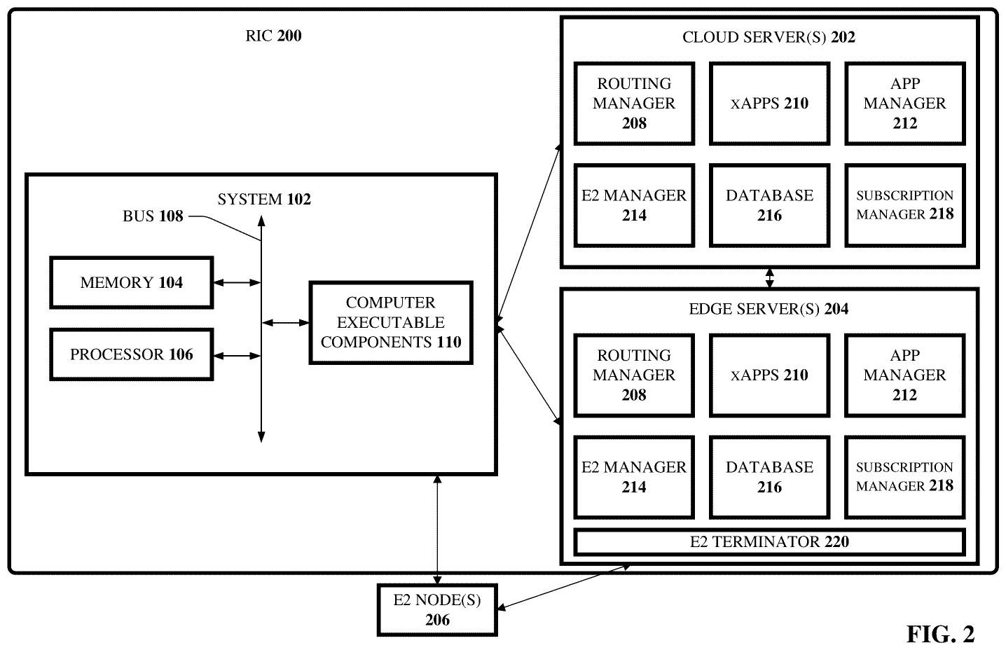

In various embodiments, the system 102 can comprise and/or be part of a RIC 200, as shown in FIG. 2. The RIC 200 can comprise one or more of a variety of components, such one or more cloud servers (e.g., or nodes or modules) 202 and/or one or more edge servers (e.g., or nodes or modules) 204. It is noted that while only one cloud server 202 and one edge server 204 are depicted in FIG. 2, it can be appreciated that the RIC 200 can comprise and/or be communicatively coupled to a plurality of cloud servers 202, edge servers 204, and/or E2 nodes 206.

The cloud server 202 can comprise the routing manager 208, xApps 210, app manager 212, E2 manager 214, database 216, and/or subscription manager 218. The edge server 204 can comprise the routing manager 208, xApps 210, app manager 212, E2 manager 214, database 216, subscription manager 218, and/or E2 terminator 220.

In various embodiments, the E2 terminator 220 must be at the edge (e.g., on an edge server 204) to ensure that the E2 node 206 to RIC latency is as low and consistent as possible, while other RIC 200 components can comprise instances in both edge and cloud machines. Edge deployed xApps 210 can utilize use RIC 200 components situated in the edge, while xApps in the cloud can rely on cloud RIC 200 components in the cloud, except for E2 terminator 220, where it will connect through the edge instance.

The routing manager 208 can determine the optimal path or route for data packets to various xApps 210. The app manager 212 can facilitate lifecycle management of xApps 210 running within the RIC 200, such as installation, updating, and/or removal of xApps 210. The E2 manager 214 can manage data flow between the xApps 210 and the E2 terminator 220 to ensure that the xApps 210 have the correct permissions and data access. The database 216 can be utilized by the xApps 210 to store corresponding data. The subscription manager 218 can manage the flow of data across all of the components of the RIC 200.

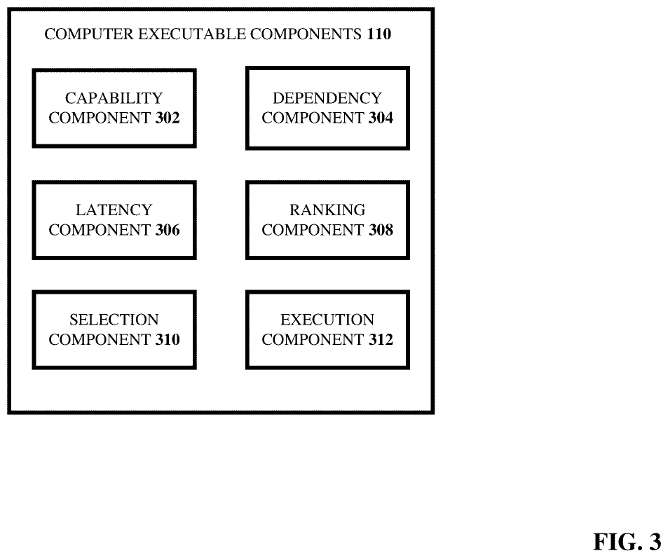

FIG. 3 illustrates a block diagram of example, non-limiting computer executable components 110 that can facilitate efficient scheduling of near RT RIC xApps in accordance with one or more embodiments described herein. Repetitive description of like elements employed in other embodiments described herein is omitted for sake of brevity. As shown in FIG. 3, the one or more computer executable components 110 can comprise the capability component 302, dependency component 304, latency component 306, ranking component 308, selection component 310, and/or execution component 312.

According to an embodiment, the capability component 302 can, based on one or more defined system requirements applicable to an xApp 210, determine, from a first group of servers (e.g., comprising the cloud servers 202 and edge servers 204), a second group of servers capable of executing the xApp 210. In various embodiments, the second group of servers can be a subset of the first group of servers. In this regard, the second group of servers can be determined (e.g., via the capability component 302) to be capable of executing the xApp 210 according to the defined system requirements applicable to the xApp 210. It is noted that, in various embodiments, the first group of servers can comprise one or more edge servers 204 and one or more cloud servers 202. In various embodiments, the one or more defined system requirements can comprise at least one of a compute requirement applicable to the xApp 210, a memory requirement applicable to the xApp 210, a latency requirement applicable to the xApp 210, or a throughput requirement applicable to the xApp 210. In various embodiments, the xApp 210 can comprise a Kubernetes based application.

According to an embodiment, the dependency component 304 can determine dependencies of the second group of servers. It is noted that, in various embodiments, the dependencies can comprise communicative connections between respective components of a RIC 200. For instance, the dependency component 304 can determine various load balancing dependencies, database dependencies, service dependencies, communication dependencies, configuration dependencies, shared resources, and/or external services applicable to the servers and/or components of the RIC 200. Additionally, or alternatively, the dependency component 304 can determine dependencies of xApps 210. In this regard, the dependency component 304 can determine the functional dependencies, library dependencies, service dependencies, data dependencies, temporal dependencies, or other suitable dependencies between xApps 210 herein.

According to an embodiment, the latency component 306 can, based on the dependencies, determine latencies applicable to the second group of servers to execute the xApp 210. In this regard, the latency component 306 can determine corresponding latencies between the second group of servers and/or between the xApps 210 that have the aforementioned dependencies determined via the dependency component 304. The latency component 306 can further, based on the latencies, determine a third group of servers that satisfy a defined latency threshold. It is noted that the third group of servers can be a subset of the second group of servers. In this regard, the latency component can filter out servers of the second group of servers that do not meet the defined latency threshold and only consider those servers (e.g., cloud servers 202 and/or edge servers 204) that meet the defined latency threshold for grouping into the third group of servers.

According to an embodiment, the ranking component 308 can, according to a defined operational cost function, rank the third group of servers based on respective operational costs. Operational costs associated with edge servers 204 can comprise one or more of hardware costs, deployment costs, maintenance costs, power and cooling costs, networks costs, space rental or leasing costs, or other suitable costs. Operational costs associated with cloud servers 202 can comprise one or more of usage-based costs, resource scaling costs, data transfer costs, management and support costs, service level agreements, or other suitable costs. The ranking component 308 can determine such operational costs associated with each server of the third group of servers. It is noted that utilization of the defined operational cost function (e.g., via the ranking component 308) can comprise normalizing and/or weighting the data for each server in the third group of servers, for instance, according to a defined data normalization and/or defined weighting process. The ranking component can then rank the third group of servers based on respective operational costs. According to an embodiment, the selection component 310 can then select a server of the third group of servers comprising a threshold low operational cost of the respective operational costs. In one or more embodiments, the selection component 310 can select the server of the third group of servers comprising the lowest operational cost of the respective operational costs. According to an embodiment, the execution component 312 can, in response to selection of the server (e.g., of the cloud servers 202 and/or edge servers 204) by the selection component 310, execute (e.g., initiate) the xApp 210 via the server. In this regard, the execution component 312 can execute the server of the third group of servers comprising the lowest operational cost of the respective operational costs.

In various embodiments, the latency component 306 can, in response to the executing (e.g., via the execution component 312) of the xApp 210 via the server, determine whether the aforementioned defined latency threshold is still satisfied. If the defined latency threshold is still satisfied, then the selected server can continue executing the xApp 210. However, the selection component 310 can, in response to a determination (e.g., via the latency component 306) that the defined latency threshold is no longer satisfied, select a different server (e.g., of the third group of servers), other than the server, to execute the xApp 210. It is noted that the different server (e.g., of the cloud servers 202 and/or edge servers 204) can also comprise the threshold low operational cost (e.g., the next lowest operational cost or threshold low operational cost).

In various embodiments, the capability component 302 can, in response to a change in the first group of servers, redetermine the second group of servers. For example, if a new edge server 204 is installed or if a new cloud server 202 is made available to the system 102 (e.g., resulting in an update to the first group of servers), the capability component 302 can determine the capabilities of the new server(s) and redetermine the second group of servers. Similarly, if a server is removed from the first group of servers, the capability component can update the second group of servers accordingly. After the second group of servers has been updated, the dependency component 304 can determine dependencies of the updated second group of servers, and the latency component 306 can, based on the dependencies, determine latencies applicable to the second group of servers to execute the xApp 210. The latency component 306 can further, based on the latencies, update the third group of servers that satisfy the defined latency threshold for the xApp 210. The ranking component 308 can then, according to the defined operational cost function, update the rankings of the third group of servers based on respective operational costs. The selection component 310 can then select a server of the third group of servers comprising a threshold low operational cost of the respective operational costs and/or the lowest respective operational cost.

The defined operational cost function can be defined and updated as follows:

### Original Cost Function:

$$φ = {\sum }_{{C}_{m} ∈ M} {T}_{m} {C}_{t} ( {C}_{m} ) + {S}_{m} {C}_{s} ( {C}_{m} ) + {SM}_{m} {C}_{sm} ( {C}_{m} ) + {AM}_{m} {C}_{am} ( {C}_{m} ) + {\sum }_{A} {A}_{m} {C}_{a} ( {C}_{m} )$$

where Tₘ, Sₘ, SMₘ, AMₘ, and Aₘ are binary piecewise functions that represent running E2 terminator 220, shared data layer (SDL), subscription manager 218, app manager 212, and xApps 210 on machine m, respectively, and Cₜ, Cₛ, Cₛₘ, Cₐₘ, and Cₐ are costs of running E2 terminator 220, shared data layer (SDL), subscription manager 218, app manager 212, and xApps 210 on machine m. φ represents the cost of running the RIC 200.

$${A}_{m} = \{ \begin{matrix}1 & if xApp runs on machine m \\ 0 & otherwise\end{matrix}$$

and M is all Kubernetes available machines.

It is noted that edge environments and cloud environments each have a complete set of RIC 200 components, and each can be utilized by respective xApps 210 within the same region, for instance, and the running cost is thus strictly tied to xApp 210 instances running and minimizing that minimizes overall cost.

In this regard, the cost function can be reduced to:

$$φ = {\sum }_{A} {A}_{m} {C}_{a} ( {C}_{M} )$$

The following constraints are noted:

$${L}^{t} = constant$$

$${L}^{t , x} = {\sum }_{{C}_{1} , {C}_{2} ∈ M} {L}^{{C}_{1} {C}_{2}} {A}_{1} {T}_{2}$$

$${L}^{x , d} = ψ {\sum }_{{C}_{1} , {C}_{2} ∈ M} {L}^{{C}_{1} {C}_{2}} {A}_{1} {D}_{2}$$

$$ψ = \{ \begin{matrix}1 & if xApp needs SDL \\ 0 & otherwise\end{matrix}$$

$${L}^{x , x} = γ {\sum }_{{C}_{1} , {C}_{2} ∈ M} {L}^{{C}_{1} {C}_{2}} {A}_{1 , 1} {A}_{2 , 2}$$

$$γ = \{ \begin{matrix}1 & if xApp 1 needs xApp 2 \\ 0 & otherwise\end{matrix}$$

$$latency = {L}^{t} + {L}^{t , x} + {L}^{x , d} + {\sum }_{a ∈ A} {L}^{x , {x}_{a}} {L}^{{x}_{a} , d}$$

$$latency \leq ρ$$

A represents all xApps (e.g., dependencies) that a scheduled xApp 210 needs in its control loop.
L^{t} is the latency between the E2 node 206 and E2 terminator 220.
L^{t,x} is the latency between the E2 terminator 220 and the xApp 210.
L^{x,d} is the latency between xApp 210 and a shared database 216.
L^{x,x} is the latency between two xApps 210.
L^{C}^{₁}^{C}^{₂} is the latency between servers C₁ and C₂.
γ denotes whether xApp1 needs xApp2 (e.g., dependencies).

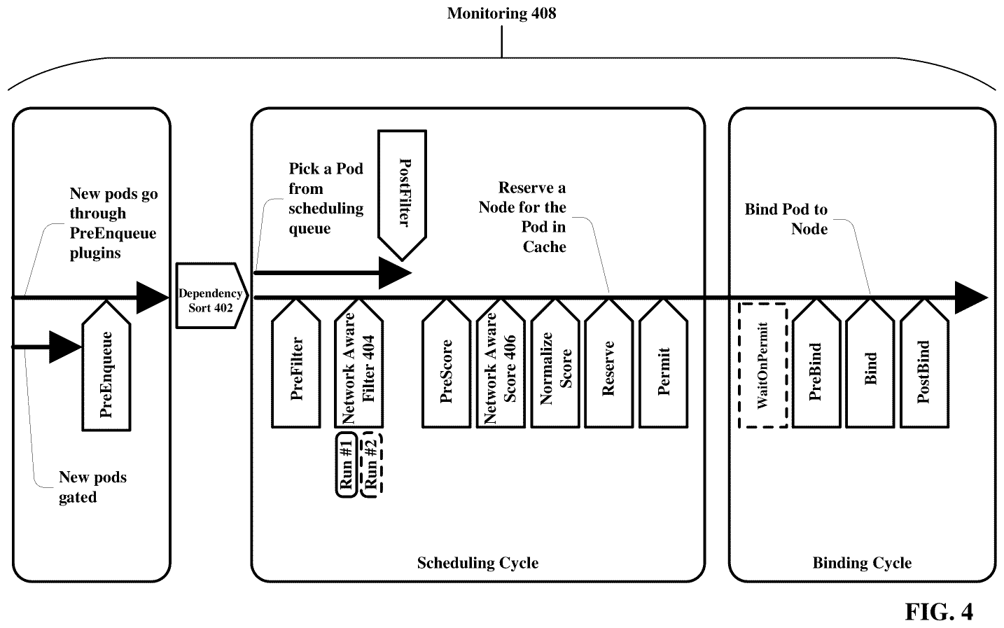

FIG. 4 is a block diagram of a non-limiting example Kubernetes scheduling in accordance with one or more example embodiments described herein. Kubernetes, also known as K8s, is an open-source system for automating deployment, scaling, and management of containerized applications. The Kubernetes Scheduler (KS) (e.g., system 102) decision making process is shown in FIG. 4. Every pod needing allocation can be added to a waiting queue, which is continuously monitored by the system 102. If a pod is added to the waiting queue, the system 102 can search for a suitable node (e.g., a server herein) for the deployment based on a two-step process.

The first step is node filtering, in which the system 102 can verify (e.g., via the capability component 302) which nodes (e.g., servers) are capable of executing the pod (e.g., comprising xApp 210) by applying a set of filters, also known as predicates. The purpose of filtering is to consider nodes meeting all specific requirements of the pod further in the scheduling process.

The second step is node priority calculation, in which the system 102 ranks (e.g., via the ranking component 308) each remaining node to find the best fit for the pod provisioning based on one or more scheduling algorithms, also called priorities.

Existing Kubernetes schedulers only consider CPU and RAM usage rates in the service scheduling, while latency or bandwidth usage rates are not considered at all. The system 102 comprises a KS that can consider latency or bandwidth usage rates.

For instance, the system 102 can perform (e.g., via the dependency component 304) dependency sort 402. In this regard, pods belonging to an AppGroup can be sorted (e.g., via the dependency component 304) based on their topology information. The DependencySort plugin enables comparison (e.g., via the system 102) of the pods' index available in the AppGroup CRD for the preferred sorting algorithm.

The system 102 can also perform (e.g., via the latency component 306) network-aware filtering at 404. In this regard, the system 102 can filter nodes (e.g., servers) capable of meeting the defined maximum cumulative network latency requirements for xApp 210.

The system 102 can also perform (e.g., via the ranking component 308) network-aware scoring at 406. In this regard, the system 102 can utilize a scoring process to favor servers with the lowest xApp 210 running costs, whether edge-based or cloud-based.

The system 102 can also perform (e.g., via the latency component 306 and/or another suitable component) monitoring 408. In this regard, the system 102 can monitor xApp 210 control loop latency and trigger rescheduling once latency violations are detected. Rescheduling can be performed by triggering a rolling update (e.g., changing annotation).

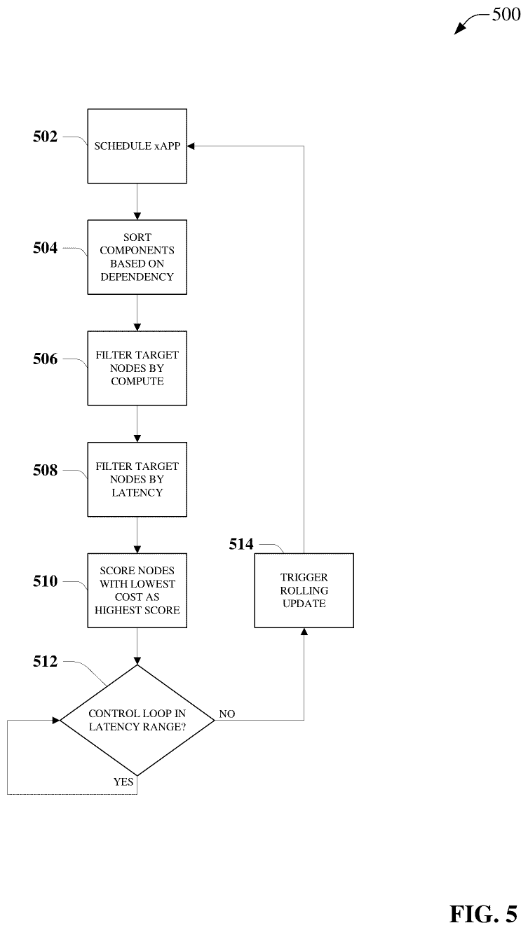

FIG. 5 is a flowchart for a process associated with efficient scheduling of near RT RIC xApps in accordance with one or more example embodiments described herein. At 502, scheduling of an xApp herein can begin (e.g., via the system 102). At 504, the dependency component 304 can determine dependencies of the servers (e.g., comprising cloud servers 202 and/or edge servers 204) herein, and/or respective components of those servers herein. The dependency component 304 can additionally, or alternatively, determine dependencies of between xApps 210 herein. At 506, the capability component 302 can determine which servers herein are capable of executing the xApp 210 and filter out the servers that are not capable of executing the xApp 210 (e.g., insufficient CPU, RAM, storage, etc.). At 508, the latency component 306 can filter servers herein by latency across an entire control loop to determine which servers comprise a threshold latency to execute the xApp 210. At 510, the ranking component 308 can rank or score the servers according to a defined cost function, which can be based on the overall operational cost associated with running that server for that xApp 210. The selection component 310 can then select the server with the highest score (e.g., lowest operational cost). At 512, if the latency of the selected server falls outside of the threshold latency (e.g., NO at 512), the process 500 can proceed to 514. If at 512, the latency of the selected server is still within the threshold latency (e.g., YES at 512), the process 500 can continue monitoring latency at 512 (e.g., via the latency component 306). At 514, a rolling update can be triggered (e.g., via the system 102), resulting in the process 500 returning to 502, and the xApp 210 can be rescheduled.

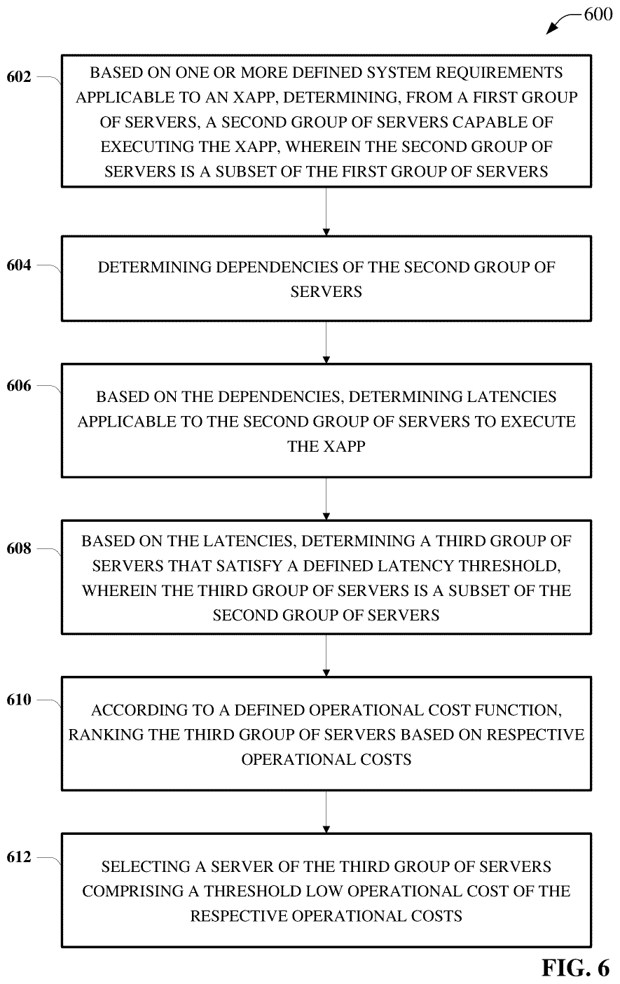

FIG. 6 illustrates a flow diagram for a process 600 associated with efficient scheduling of near RT RIC xApp in accordance with one or more embodiments described herein. At 602, the process 600 can comprise, based on one or more defined system requirements applicable to an xApp 210, determining (e.g., via the capability component 302), from a first group of servers (e.g., comprising cloud servers 202 and/or edge servers 204), a second group of servers capable of executing the xApp 210, wherein the second group of servers is a subset of the first group of servers. At 604, the process 600 can comprise determining (e.g., via the dependency component 304) dependencies of the second group of servers. At 606, the process 600 can comprise, based on the dependencies, determining (e.g., via the latency component 306) latencies applicable to the second group of servers to execute the xApp 210. At 608, the process 600 can comprise, based on the latencies, determining (e.g., via the latency component 306) a third group of servers that satisfy a defined latency threshold, wherein the third group of servers is a subset of the second group of servers. At 610, the process 600 can comprise, according to a defined operational cost function, ranking (e.g., via the ranking component 308) the third group of servers based on respective operational costs. At 612, the process 600 can comprise selecting (e.g., via the selection component 310) a server of the third group of servers comprising a threshold low operational cost of the respective operational costs.

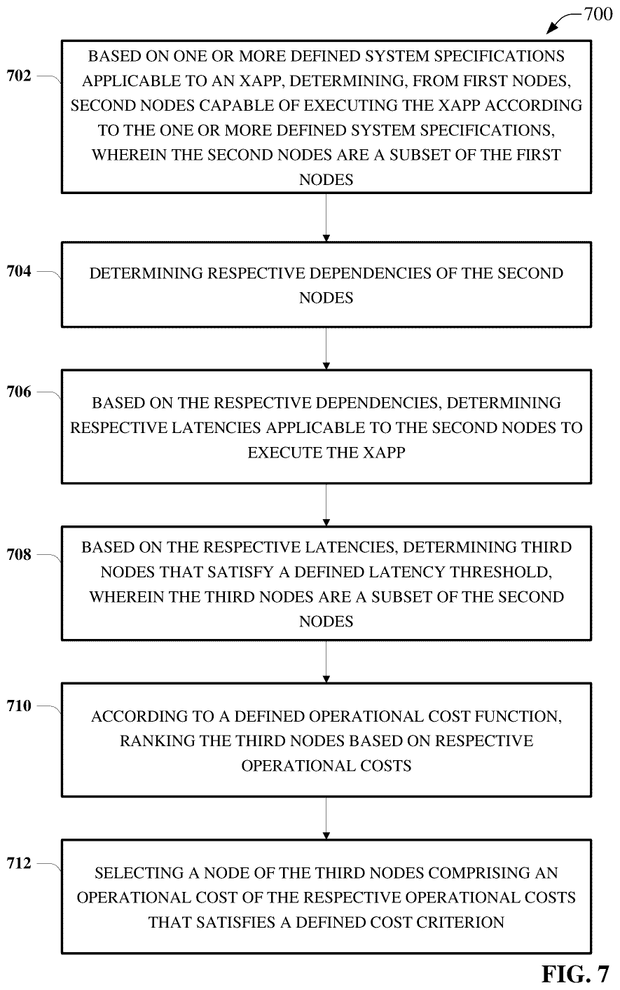

FIG. 7 illustrates a flow diagram for a process 700 associated with efficient scheduling of near RT RIC xApp in accordance with one or more embodiments described herein. At 702, the process 700 can comprise, based on one or more defined system specifications applicable to an xApp 210, determining (e.g., via the capability component 302), from first nodes (e.g., comprising cloud servers 202 and/or edge servers 204), second nodes capable of executing the xApp 210 according to the one or more defined system specifications, wherein the second nodes are a subset of the first nodes. At 704, the process 700 can comprise determining (e.g., via the dependency component 304) respective dependencies of the second nodes. At 706, the process 700 can comprise, based on the respective dependencies, determining (e.g., via the latency component 306) respective latencies applicable to the second nodes to execute the xApp 210. At 708, the process 700 can comprise, based on the respective latencies, determining (e.g., via the latency component 306) third nodes that satisfy a defined latency threshold, wherein the third nodes are a subset of the second nodes. At 710, the process 700 can comprise, according to a defined operational cost function, ranking (e.g., via the ranking component 308) the third nodes based on respective operational costs. At 712, the process 700 can comprise selecting (e.g., via the selection component 310) a node of the third nodes comprising an operational cost of the respective operational costs that satisfies a defined cost criterion.

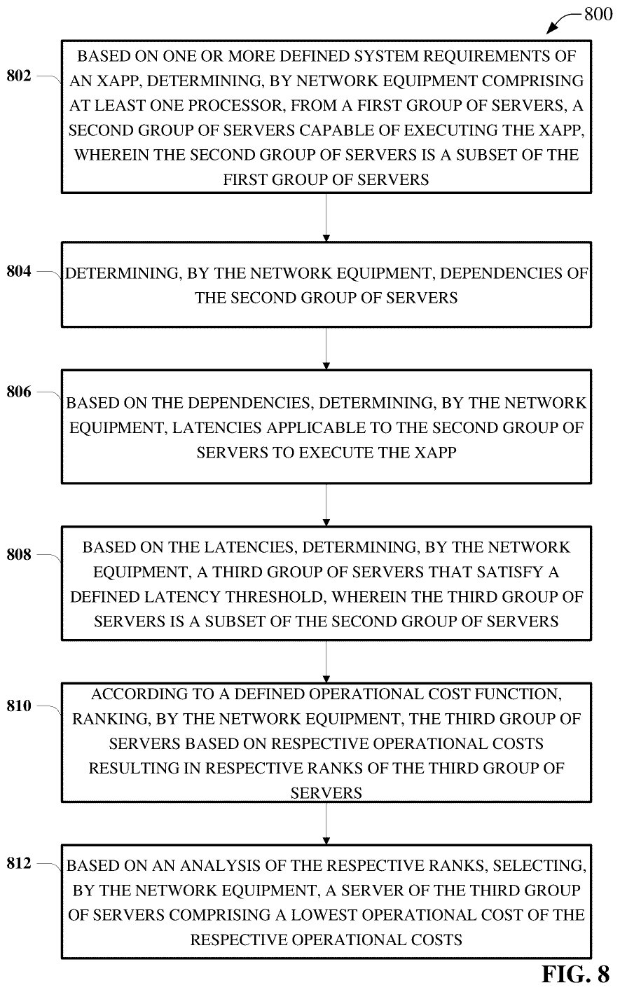

FIG. 8 illustrates a flow diagram for a process 800 associated with efficient scheduling of near RT RIC xApp in accordance with one or more embodiments described herein. At 802, the process 800 can comprise, based on one or more defined system requirements of an xApp 210, determining (e.g., via the capability component 302), by network equipment comprising at least one processor, from a first group of servers (e.g., comprising cloud servers 202 and/or edge servers 204), a second group of servers capable of executing the xApp, wherein the second group of servers is a subset of the first group of servers. At 804, the process 800 can comprise, determining (e.g., via the dependency component 304), by the network equipment, dependencies of the second group of servers. At 806, the process 800 can comprise, based on the dependencies, determining (e.g., via the latency component 306), by the network equipment, latencies applicable to the second group of servers to execute the xApp 210. At 808, the process 800 can comprise, based on the latencies, determining (e.g., via the latency component 306), by the network equipment, a third group of servers that satisfy a defined latency threshold, wherein the third group of servers is a subset of the second group of servers. At 810, the process 800 can comprise, according to a defined operational cost function, ranking (e.g., via the ranking component 308), by the network equipment, the third group of servers based on respective operational costs resulting in respective ranks of the third group of servers. At 812, the process 800 can comprise, based on an analysis of the respective ranks, selecting (e.g., via the selection component 310), by the network equipment, a server of the third group of servers comprising a lowest operational cost of the respective operational costs.

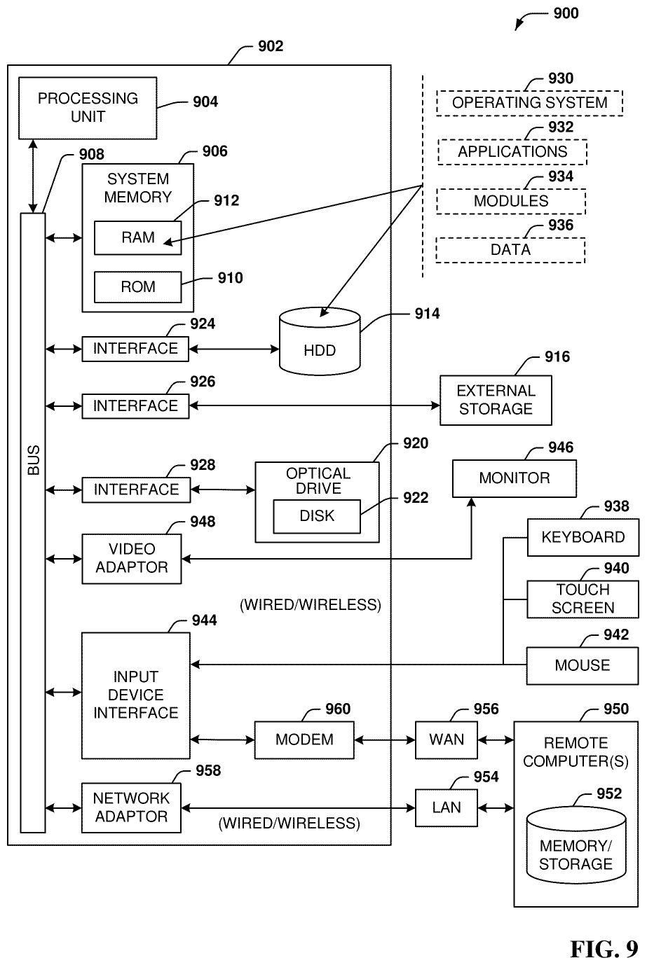

In order to provide additional context for various embodiments described herein, FIG. 9 and the following discussion are intended to provide a brief, general description of a suitable computing environment 900 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, modules, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared, and other wireless media.

With reference again to FIG. 9, the example environment 900 for implementing various embodiments of the aspects described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and an optical disk drive 920 (e.g., which can read or write from a disk 922, such as a CD-ROM disc, a DVD, a BD, etc.). While the internal HDD 914 is illustrated as located within the computer 902, the internal HDD 914 can also be configured for external use in a suitable chassis (not shown). Additionally, while not shown in environment 900, a solid-state drive (SSD) could be used in addition to, or in place of, an HDD 914. The HDD 914, external storage device(s) 916 and optical disk drive 920 can be connected to the system bus 908 by an HDD interface 924, an external storage interface 926 and an optical drive interface 928, respectively. The interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the .NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enabled with a security module, such as a trusted processing module (TPM). For instance, with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 946 or other type of display device can also be connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the Internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are examples and other means of establishing a communications link between the computers can be used.

When used in either a LAN or WAN networking environment, the computer 902 can access cloud storage systems or other network-based storage systems in addition to, or in place of, external storage devices 916 as described above. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

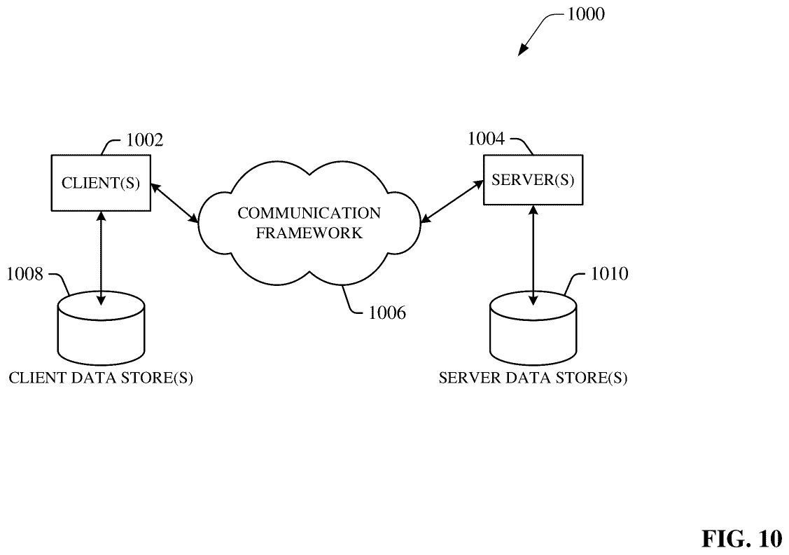

Referring now to FIG. 10, there is illustrated a schematic block diagram of a computing environment 1000 in accordance with this specification. The system 1000 includes one or more client(s) 1002, (e.g., computers, smart phones, tablets, cameras, PDA's). The client(s) 1002 can be hardware and/or software (e.g., threads, processes, computing devices). The client(s) 1002 can house cookie(s) and/or associated contextual information by employing the specification, for example.

The system 1000 also includes one or more server(s) 1004. The server(s) 1004 can also be hardware or hardware in combination with software (e.g., threads, processes, computing devices). The servers 1004 can house threads to perform transformations of media items by employing aspects of this disclosure, for example. One possible communication between a client 1002 and a server 1004 can be in the form of a data packet adapted to be transmitted between two or more computer processes wherein data packets may include coded analyzed headspaces and/or input. The data packet can include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

In one exemplary implementation, a client 1002 can transfer an encoded file, (e.g., encoded media item), to server 1004. Server 1004 can store the file, decode the file, or transmit the file to another client 1002. It is noted that a client 1002 can also transfer uncompressed files to a server 1004 and server 1004 can compress the file and/or transform the file in accordance with this disclosure. Likewise, server 1004 can encode information and transmit the information via communication framework 1006 to one or more clients 1002.

The illustrated aspects of the disclosure may also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components, modules, or methods for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, modules, devices, circuits, systems, etc., the terms (including a reference to a “means”) used to describe such components or modules are intended to also include, unless otherwise indicated, any structure(s) which performs the specified function of the described component or module (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one processor; and
at least one memory that stores executable instructions that, when executed by the at least one processor, facilitate performance of operations, comprising:
based on one or more defined system requirements applicable to an xApp, determining, from a first group of servers, a second group of servers capable of executing the xApp, wherein the second group of servers is a subset of the first group of servers;
determining dependencies of the second group of servers;
based on the dependencies, determining latencies applicable to the second group of servers to execute the xApp;
based on the latencies, determining a third group of servers that satisfy a defined latency threshold, wherein the third group of servers is a subset of the second group of servers;
according to a defined operational cost function, ranking the third group of servers based on respective operational costs; and
selecting a server of the third group of servers comprising a threshold low operational cost of the respective operational costs.

2. The system of claim 1, wherein selecting the server comprises selecting the server of the third group of servers comprising the lowest operational cost of the respective operational costs.

3. The system of claim 1, wherein the operations further comprise:
in response to selecting the server, executing the xApp via the server; and
in response to executing the xApp via the server, determining whether the defined latency threshold is still satisfied.

4. The system of claim 3, wherein the operations further comprise:
in response to a determination that the defined latency threshold is no longer satisfied, selecting a different server, other than the server, to execute the xApp, wherein the different server also comprises the threshold low operational cost.

5. The system of claim 1, wherein the first group of servers comprises one or more edge servers and one or more cloud servers.

6. The system of claim 1, wherein the dependencies comprise communicative connections between respective components of a radio intelligent controller.

7. The system of claim 1, wherein the one or more defined system requirements comprise at least one of a compute requirement applicable to the xApp, a memory requirement applicable to the xApp, a latency requirement applicable to the xApp, or a throughput requirement applicable to the xApp.

8. The system of claim 1, wherein the xApp comprises a Kubernetes based application.

9. The system of claim 1, wherein the operations further comprise:
in response to a change in the first group of servers, redetermining the second group of servers.

10. A non-transitory machine-readable medium, comprising executable instructions that, when executed by at least one processor, facilitate performance of operations, comprising:
based on one or more defined system specifications applicable to an xApp, determining, from first nodes, second nodes capable of executing the xApp according to the one or more defined system specifications, wherein the second nodes are a subset of the first nodes;
determining respective dependencies of the second nodes;
based on the respective dependencies, determining respective latencies applicable to the second nodes to execute the xApp;
based on the respective latencies, determining third nodes that satisfy a defined latency threshold, wherein the third nodes are a subset of the second nodes;
according to a defined operational cost function, ranking the third nodes based on respective operational costs; and
selecting a node of the third nodes comprising an operational cost of the respective operational costs that satisfies a defined cost criterion.

11. The non-transitory machine-readable medium of claim 10, wherein the operations further comprise:
in response to selecting the node, executing the xApp via the node.

12. The non-transitory machine-readable medium of claim 11, wherein the operations further comprise:
after executing the xApp via the node, determining whether the defined latency threshold is still satisfied.

13. The non-transitory machine-readable medium of claim 12, wherein the operations further comprise:
in response to the determining indicating that the defined latency threshold is no longer satisfied, determining another node, other than the node, to execute the xApp.

14. The non-transitory machine-readable medium of claim 10, wherein the first nodes comprise one or more edge nodes and one or more cloud nodes.

15. The non-transitory machine-readable medium of claim 10, wherein the respective dependencies comprise communicative connections between respective modules of a radio intelligent controller.

16. The non-transitory machine-readable medium of claim 10, wherein the one or more defined system specifications comprise at least one of a compute specification applicable to the xApp, a memory specification applicable to the xApp, a latency specification applicable to the xApp, or a throughput specification applicable to the xApp.

17. A method, comprising:
based on one or more defined system requirements of an xApp, determining, by network equipment comprising at least one processor, from a first group of servers, a second group of servers capable of executing the xApp, wherein the second group of servers is a subset of the first group of servers;
determining, by the network equipment, dependencies of the second group of servers;
based on the dependencies, determining, by the network equipment, latencies applicable to the second group of servers to execute the xApp;
based on the latencies, determining, by the network equipment, a third group of servers that satisfy a defined latency threshold, wherein the third group of servers is a subset of the second group of servers;
according to a defined operational cost function, ranking, by the network equipment, the third group of servers based on respective operational costs resulting in respective ranks of the third group of servers; and
based on an analysis of the respective ranks, selecting, by the network equipment, a server of the third group of servers comprising a lowest operational cost of the respective operational costs.

18. The method of claim 17, further comprising:
in response to selecting the server, initiating, by the network equipment, execution of the xApp via the server.

19. The method of claim 18, further comprising:
after the initiating of the execution of the xApp via the server, determining, by the network equipment, that the defined latency threshold is not satisfied.

20. The method of claim 19, further comprising:
in response to the determining that the defined latency threshold is not satisfied, determining, by the network equipment, a different server, other than the server having the lowest operational cost, to execute the xApp, the different server having a next lowest operational cost of the respective operational costs.
